(19) United States
(12) Patent Application Publication
(10) Pub. No.: US 2015/0167776 A1
(43) Pub. Date: Jun. 18, 2015

(54) SAFETY DAMPER

(71) Applicant: Hyundai Motor Company, Seoul (KR)

(72) Inventors: Hyun Seop Lim, Anyang (KR); Kyung Mo Jung, Seongnam (KR)

(21) Appl. No.: 14/325,832

(22) Filed: Jul. 8, 2014

(30) Foreign Application Priority Data
Dec. 13, 2013 (KR) 10-2013-0155493

(51) Int. Cl. F16F 9/49; F16F 9/19

(52) U.S. Cl. CPC F16F 9/49; F16F 9/19

(57) ABSTRACT

A safety damper includes a cylinder having a circular cross-section and a piston shaped as a disk having a predetermined thickness. The piston is inserted into the cylinder and has a through-hole. A safety plate is shaped as a disk having a predetermined thickness, is spaced a predetermined distance from and coupled with the piston, and has a hole corresponding to the through-hole of the piston. A piston rod extends through and is coupled with the piston and the safety plate. An elastic member is provided between the piston and the safety plate.

### CROSS REFERENCE TO RELATED APPLICATION

The present application claims under 35 U.S.C. §119(a) the benefit of Korean Patent Application No. 10-2013-0155493, filed on Dec. 13, 2013, which is incorporated by reference herein in its entirety.

### BACKGROUND

(a) Field of the Invention

The present invention relates to a safety damper, and more particularly, to a safety damper which can act as a hydraulic damper using a structure including a cylinder and a piston.

(b) Description of the Related Art

In general, a vehicle requires a low damping ratio in order to improve the impression of riding in the vehicle, and counteract vibration and shocks while the vehicle is being driven. During high-speed driving, the vehicle requires a high damping ratio in order to realize riding stability and turning stability.

For these reasons, there is required a damper which is intended to minimize the vibration of a main body of a vehicle by absorbing all of the different types of shocks that occur depending on the condition of different roads while the vehicle is being driven. The damper is also intended to buffer the vibration of the main body and the vibration of the wheels of the vehicle, which have different frequency response characteristics.

An example of a hydraulic damper is disclosed in Korean Patent Publication No. 10-2012-0076082 A. According to this document, a walking aid device that protects an ankle includes a foot stand part, at least one piston, and at least one encoder. The foot stand part supports a foot sole. A bearing part supports the foot stand part with at least two degrees of freedom of rotation. The piston is connected perpendicularly to the upper portion of the bearing part, and moves upward and downward inside a cylinder in which MR fluid is contained. The encoder measures the displacement of the piston per hour inside the cylinder. An MR damper part connects the upper and lower portions to each other via at least one branch tube, in which MR fluid is contained. Magnets are disposed in the MR damper part, adjacent to the branch tube, and can induce a magnetic field. The walking aid device varies the damping force of the MR damper part depending on the displacement per hour measured by the encoder.

However, this conventional hydraulic damper has at least the following problems. Since the structure is complicated and the damping force is fixed to a preset value, it is therefore impossible to satisfy various requirements for the damping force in order to improve, for example, the impression of riding and safety depending on the operating status of transportation machines and other mechanical apparatuses. In addition, the inside of the damper may be damaged, thereby reducing the longevity of the damper.

The foregoing is intended merely to aid in the understanding of the background of the present invention, and is not intended to mean that the present invention falls within the purview of the related art that is already known to those skilled in the art.

### SUMMARY

The present invention discloses a safety damper which has a simple structure, satisfies various types of damping forces, and does not cause damage to the damper, such that the damper can be used semi-permanently.

In order to achieve the above object, according to one aspect of the present invention, there is provided a safety damper that includes: a cylinder having a circular cross-section; a piston shaped as a disk having a predetermined thickness, the piston being inserted into the cylinder and having a through-hole; and a safety plate. The safety plate is shaped as a disk having a predetermined thickness, is spaced a predetermined distance from and coupled with the piston, and has a hole corresponding to the through-hole of the piston. The safety damper also includes a piston rod extending through the piston and the safety plate. The piston rod is coupled with the piston and the safety plate. The safety damper also includes an elastic member provided between the piston and the safety plate.

According to an embodiment of the present invention, each diameter of the piston and the safety plate may be substantially identical with the inner diameter of the cylinder, such that the safety plate and the piston slide inside the cylinder in a longitudinal direction while blocking an inside of the cylinder.

The piston may be thicker than the safety plate.

The shape of the through-hole of the piston may correspond to a shape of the corresponding hole of the safety plate. The through-hole and the corresponding hole may be positioned so as to alternate with each other. The inside of the cylinder preferably is completely blocked when the piston and the safety plate are abutted to each other.

The through-hole may be a plurality of through-holes spaced apart predetermined distances from each other. The corresponding hole may be a plurality of corresponding holes spaced apart predetermined distances from each other.

The piston may have a seating recess at a central portion, the seating recess having a concave shape into the piston. The elastic member may be closely abutted to the seating recess.

The seating recess may be seating recesses formed on both side surfaces of the piston.

The predetermined distance from the piston to the safety plate may be maintained by the elastic member.

The safety plate may be safety plates which are provided on both sides of the piston.

Fluid may be contained inside the cylinder.

When a force smaller than a predetermined size is applied to the cylinder, the fluid may flow against resistance of a force formed between the piston and the safety plate, so that the cylinder acts as a damper.

When a force equal to or greater than the predetermined size is applied to the cylinder, the elastic member may be compressed so that the piston and the safety plate are abutted to each other, thereby blocking an inside of the cylinder, so that the fluid does not flow. The cylinder consequently acts as a brake.

The elastic member may be implemented as a coil spring which is wound on an outer circumference of the piston rod.

The elastic member may be implemented as elastic members provided on both sides of the piston.

According to the safety damper having the above-described structure, it is possible to realize both a damper and a brake using one device. This can consequently provide a simple structure that does not significantly increase the weight, satisfies various types of damping force, and secures the safety of a user.

The safety damper according to the invention does not require a separate power source. Since a mechanical structure is used, a control technology for securing safety is not required. The electrical efficiency is increased since power loss is reduced. The safety damper can be used semi-permanently since the damper is not damaged. Since the safety damper can be applied to not only wearable robots but also the other devices or parts through the adjustment of the elasticity of the elastic members, there is the advantage of the common use of parts.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing an embodiment of a safety damper according to the invention;

FIG. 2 is a detailed perspective view of the piston and the elastic member shown in FIG. 1;

FIG. 3 is a perspective view showing an arrangement in which the safety damper acts as a damper;

FIGS. 4 and 5 are perspective views showing an arrangement in which the safety damper acts as a brake; and

FIG. 6 is a view showing an embodiment of the safety damper according to the invention that is applied to a robot.

### DETAILED DESCRIPTION OF THE INVENTION

Hereinbelow, exemplary embodiments of a safety damper according to the present invention will be described in detail with reference to the accompanying drawings

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

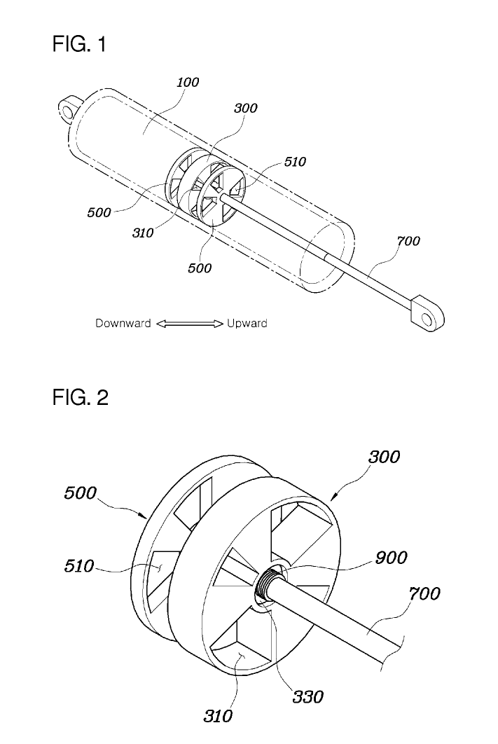

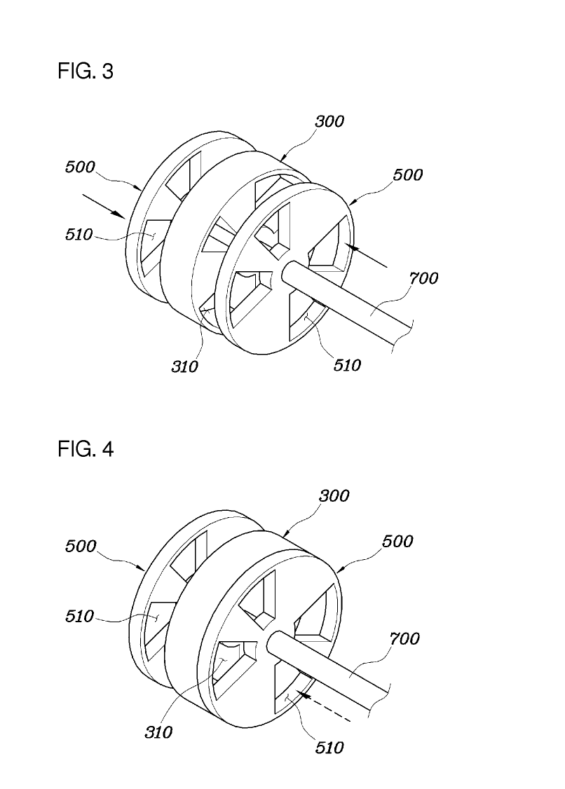

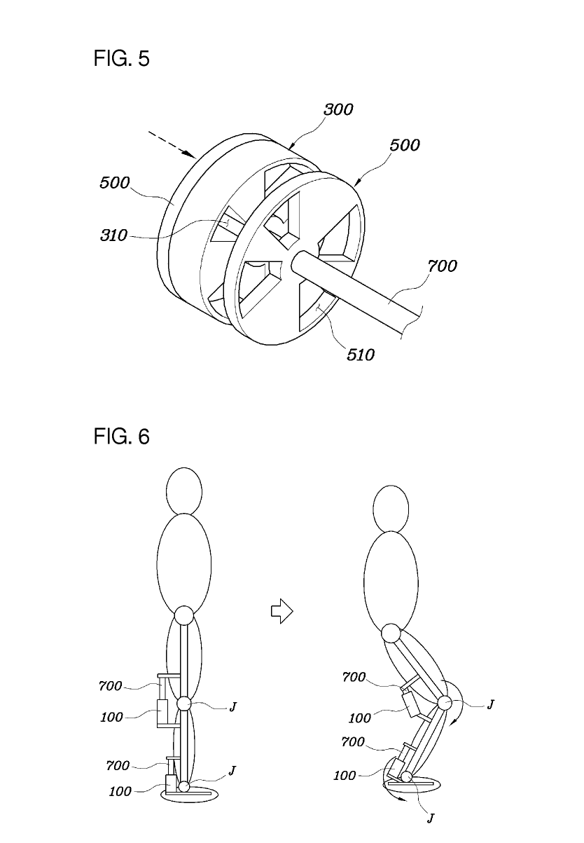

FIG. 1 is a perspective view showing an embodiment of a safety damper according to the invention, FIG. 2 is a detailed perspective view of a piston 300 and an elastic member 900, FIG. 3 is a perspective view of the safety damper acting as a damper, FIGS. 4 and 5 are perspective views of the safety damper acting as a brake, and FIG. 6 is a view of an embodiment of the safety damper that is applied to a robot.

The safety damper according to an exemplary embodiment of the invention includes a cylinder 100, a piston 300, safety plates 500, a piston rod 700 and elastic members 900. The cylinder 100 is shaped as a chamber having a circular cross-section. The piston 300 is shaped as a disk having a preset thickness, is inserted into the cylinder 100, and has through-holes 310. Each of the safety plates 500 is shaped as a disk having a preset thickness, is spaced a preset distance from the piston 300, is coupled with the piston 300, and has corresponding holes 510. The piston rod 700 extends through and is coupled with the piston 300 and the safety plates 500. The elastic members 900 are provided between the piston 300 and the safety plates 500. In some cases, fluid may be contained in the cylinder 100. The fluid collectively refers to liquid and gas that are fluidic, and can be sufficiently implemented as air inside the cylinder.

Although the cylinder 100 is illustrated as being a chamber having a circular cross-section, and the piston 300 and the safety plates 500 are illustrated as being disks having a preset thickness in this embodiment, it is apparent to a person skilled in the art that such shapes can be variously altered as required by a design or environment.

The piston 300 and the safety plates 500 which are provided at both sides of the piston 300 are positioned inside the cylinder 100. The piston rod 700 extends through and is coupled to the piston 300 and the safety plates 500. The piston 300 and the safety plates 500 preferably stay at preset distances from each other. The elastic members 900 are positioned at both sides of the piston 300, in particular, between the piston 300 and the safety plates 500, and are wound on the outer circumference of the piston rod 700 such that the piston 300 and the safety plates 500 elastically are configured to stay at preset distances from each other. The elastic members 900 can be implemented as compressive coil springs.

The diameter of each of the piston 300 and the safety plates 500 is substantially the same as the inner diameter of cylinder 100. The piston 300 preferably is thicker than each of the safety plates 500. The piston 300 and the safety plates 500 are removed in part in the thickness direction such that the fan-shaped through-holes 310 and the corresponding holes 510 are formed therein. The holes 310 and 510 have the same shape, but the through-holes 310 of the piston 300 and the corresponding holes 510 of the safety plates 500 are formed at different positions such that the through-holes 310 do not overlap the corresponding holes 510.

With this configuration, although the piston 300 and the safety plates 500 are arranged inside the cylinder 100, fluid can circulate through the holes 310 and 510. In response to the movement of the piston rod 700, the safety plates 500 and the piston 300 slide individually or together inside the cylinder 100 in the longitudinal direction.

In particular, the through-holes 310 of the piston 300 and the corresponding holes 510 of the safety plates 500 are formed in a plurality of numbers, are spaced apart from each other at preset distances, and are positioned to alternate with each other. Consequently, the piston 300 is positioned differently from the safety plates 500 depending on force acting on the cylinder 100 and the piston rod 700. When the piston 300 abuts against at least one of the safety plates 500, a complete blockage is temporarily created, thereby preventing fluid from moving from one side to the other side of the piston 300. This operation will be described later.

The piston 300 also has a seating recess 330 at a central portion about a point of the piston 300 so as to have a concave shape into the piston 300 through which the piston rod 700 penetrates. This consequently causes the elastic members 700 to be closely abutted to the seating recess 330 when the elastic members 700 are compressed, thereby preventing the elastic members 700 from being dislodged while guiding the elastic members 700. A seating recess 330 is also formed on the bottom surface of the piston 300, such that the seating recesses 330 are respectively formed on both side surfaces of the piston 300.

FIG. 3 is a view showing an arrangement in which the safety damper acts as a damper. As shown in FIG. 3, when a force smaller than a preset size is applied to the piston rod 700 and the cylinder 100 from above and below (or either) as indicated by arrows in the figure, fluid overcomes the resistance of the acting between the piston 300 and the safety plates 500 and freely moves through the through-holes 310 of the piston 300 and the corresponding holes of the safety plates 500 so that the safety damper acts as a damper.

However, as indicated by arrows in FIGS. 4 and 5, when a force equal to or greater than a preset size is applied to the piston rod 700 and the cylinder 100 from above and/or below, the elastic members 900 are abruptly compressed by the applied force so that the safety plates 500 abut against the piston 300, thereby closing the through-holes 310 and the corresponding holes 510 which are misaligned. Consequently, fluid inside the cylinder 100 fails to pass through between the piston 300 and the safety plates 500, so that the safety damper acts as a brake.

According to the present invention, this arrangement is advantageous in that the force having a preset size as described above can be freely changed as the elastic force of the elastic members 900 is adjusted.

FIG. 6 is a view showing an embodiment of the invention applied to a wearable robot. When a user wears a wearable robot, the user may be injured due to two different factors. First, the user may be injured because an accidental motion occurs due to erroneous control over the robot. The user may also be injured by shocks created when the soles of the robot touch the ground while walking.

It is important to prevent such issues, since these factors lead to the reduced longevity or destruction of parts of a robot mechanism. Therefore, in the case of erroneous control over the robot, a solution of mounting a contact brake or a safety joint is used. In the case in which shocks are created by the touching of the ground, an elastic rubber plate or the like is coupled to a foot module or a mechanical cylinder using hydraulic power is mounted on the foot module.

However, these approaches increase the weight and the number of parts of the robot, thereby disadvantageously complicating the structure and increasing the fabrication cost.

When the safety damper according to the invention is used for a joint J of the robot, it is possible to realize both a damper and a brake using one device. This can consequently provide a simple structure that does not significantly increase the weight, satisfies various types of damping force, and secures the safety of a user.

The safety damper according to the invention does not require a separate power source. Since a mechanical structure is used, a control technology for securing safety is not required. The electrical efficiency is increased since power loss is reduced. The safety damper can be used semi-permanently since the damper is not damaged. Since the safety damper can be applied to not only wearable robots but also the other devices or parts through the adjustment of the elasticity of the elastic members, there is the advantage of the common use of parts.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A safety damper comprising:
a cylinder having a circular cross-section;
a piston shaped as a disk having a predetermined thickness, the piston being inserted into the cylinder and having a through-hole;
a safety plate, wherein the safety plate has a disk shape with a predetermined thickness, is spaced a predetermined distance from and coupled with the piston, and has a hole corresponding to the through-hole of the piston;
a piston rod extending through and being coupled with the piston and the safety plate; and
an elastic member provided between the piston and the safety plate.

2. The safety damper according to claim 1, wherein each diameter of the piston and the safety plate is substantially identical with an inner diameter of the cylinder, such that the safety plate and the piston slide inside the cylinder in a longitudinal direction while blocking an inside of the cylinder.

3. The safety damper according to claim 1, wherein the piston is thicker than the safety plate.

4. The safety damper according to claim 1, wherein a shape of the through-hole of the piston corresponds to a shape of the corresponding hole of the safety plate, and the through-hole and the corresponding hole are positioned so as to alternate with each other, such that an inside of the cylinder is completely blocked when the piston and the safety plate abut against each other.

5. The safety damper according to claim 4, wherein the through-hole comprises a plurality of through-holes spaced apart predetermined distances from each other, and the corresponding hole comprises a plurality of corresponding holes spaced apart predetermined distances from each other.

6. The safety damper according to claim 1, wherein the piston has a seating recess at a central portion, the seating recess having a concave shape into the piston, and the elastic member is closely abutted to the seating recess.

7. The safety damper according to claim 6, wherein the seating recess comprises seating recesses formed on both side surfaces of the piston.

8. The safety damper according to claim 1, wherein the predetermined distance from the piston to the safety plate is maintained by the elastic member.

9. The safety damper according to claim 1, wherein the safety plate comprises safety plates which are provided on both sides of the piston.

10. The safety damper according to claim 1, wherein fluid is contained inside the cylinder.

11. The safety damper according to claim 10, wherein, when a force smaller than a predetermined size is applied to the cylinder, the fluid flows against resistance of a force formed between the piston and the safety plate, whereby the cylinder acts as a damper.

12. The safety damper according to claim 10, wherein, when a force equal to or greater than the predetermined size is applied to the cylinder, the elastic member is compressed so that the piston and the safety plate abut against each other, thereby blocking an inside of the cylinder, so that the fluid does not flow, whereby the cylinder acts as a brake.

13. The safety damper according to claim 1, wherein the elastic member comprises a coil spring which is wound on an outer circumference of the piston rod.

14. The safety damper according to claim 1, wherein the elastic member comprises elastic members provided on both sides of the piston.
